(19) United States
(12) Patent Application Publication
(10) Pub. No.: US 2013/0123489 A1
(43) Pub. Date: May 16, 2013

(54) PROCESS FOR REMOVING DIVALENT CATIONS FROM MILK BY-PRODUCTS

(71) Applicant: Fred Neumann, Steffisburg (CH)

(72) Inventor: Fred Neumann, Steffisburg (CH)

(21) Appl. No.: 13/642,696

(22) PCT Filed: Apr. 22, 2011
(86) PCT No.: PCT/IB11/51771

§ 371 Date: Dec. 17, 2012

(30) Foreign Application Priority Data
Apr. 22, 2010 (NL) 2004594

(51) Int. Cl. A23C 7/04

(52) U.S. Cl. CPC A23C 7/043
USPC 536/123.13; 426/271; 426/244; 426/583

(57) ABSTRACT

A process for removing divalent cations, such as magnesium and calcium, from milk by-products, such as whey from cheese making and whey by-products from membrane processes, wherein the weak cationic resin is in the alkali form.

The present invention relates to a process for removing divalent cations from milk by-products, particularly whey from cheese making, but also whey by-products from membrane processes.

U.S. Pat. No. 2,778,750 relates to an ion exchange purification of whey in the preparation of lactose. A bed of a cation exchange resin is prepared and treated with a 10% aqueous solution of sodium chloride to put the resin in a sodium cycle.

US 2005/0170062 relates to a method for producing a low fat spread comprising 1-7% whey protein in which method a whey protein concentrate of high total solids was passed through a weak cation exchange resin.

U.S. Pat. No. 6,033,700 relates to an electrodeionization process for demineralizing a substrate by passing a substrate through an ion exchange resin bed contained in a dilution compartment.

WO 2007/026053 relates to a method for the production of low calcium milk, in which the milk product is subjected to ion exchange treatment.

U.S. Pat. No. 4,803,089 relates to a process for the decationization of by-products of milk, particularly whey for cheese making, by ion exchange, comprising passing the by-product in liquid form successively through a weak cationic resin and then through a strong cationic resin and then regenerating the resins by passing an acid successively through the strong cationic resin and then through the weak cationic resin. The resin used in this document is in the H-form which will result in a reduced capacity of the resin and an incomplete reduction of Mg and Ca ions due to the rapid drop of the pH-value during percolation.

A common combination for whey demineralisation starts with nanofiltration of the whey followed successively by electrodialysis and cation and anion exchange to produce finally demineralised whey with a demineralisation degree of 90%. At the start at high conductivity of the whey concentrate, electrodialysis will take out preferably the monovalent ions sodium, potassium and chloride. After achieving a demineralisation degree of about 50 to 60% remaining ions are mainly magnesium, calcium, citrate and phosphate. These ions form a number of complexes between each other and also with proteins and peptides of the whey. These complexes have only low conductivity and are bulky, which results in a fast reduction of the performance of the electrodialysis. Consequently the targeted demineralisation degrees >90% can be realised only by finishing up with ion exchange treatment. Structure of running costs and composition of effluents are totally different for these two steps. While costs of chemicals are low in electrodialysis processing, major costs arise from maintenance working hours and capital costs for membrane replacement in the electrodialysis stacks due to fouling.

In ion exchange chemicals and minerals are the main cost factor, both costs of acid and lye, but more importantly costs of managing salt loads, which are released after regeneration from the columns. While the mineral content of whey makes up about 10% of whey dry matter, additional mineral release from the regeneration of the ion exchange resin can be estimated by multiplying whey minerals with a factor of 2 to 2.5 to respect all chemicals, which are spent for resin regeneration. This calculation results for a plant to demineralise 100 tons of whey dry matter per day in 20 to 25 tons of minerals. Allowance to dispose these salts to the environment is under constantly increasing pressure all around the world.

Actually it is very complicated to separate minerals for any further usage, since all different species of ions are mixed up in the effluent flows.

Attempts to achieve improvement of electrodialysis are focused on influencing the ionic equilibrium in the whey. One recommendation in this regard is to operate electrodialysis at lower pH-values in the brine. Nevertheless, such a system allows demineralisation by electrodialysis not much higher than 70%. For higher demineralisation degrees still other processes are needed.

In the dairy industry, as in many other industries, the presence of calcium and/or magnesium in liquids to be treated restricts some operations and particularly the operations of concentration of these liquids.

Thus, for instance, in the case of the production of crystallized lactose from whey, the presence of calcium interferes with the concentration of this whey and limits the quality of the lactose produced due to a co-precipitation of calcium salt.

The presence of calcium and/or magnesium also restrains the use of the separation methods used for the purification, such as the electrodialysis or the chromatography.

The object of the present invention is to provide an effect process for removing divalent cations, e.g. magnesium and calcium, from milk by-products.

The present invention relates to a process for removing divalent cations from milk by-products comprising passing said milk by-products through a weak cationic resin (WAC), wherein said weak cationic resin (WAC) is in the alkali form.

Essential target of the present invention is to develop, for all processes on whey and other milk by-products as mentioned above, an initial step after which the starting material will enter into down stream treatment free of Mg and Ca ions.

In an initial process step all Ca and Mg ions of a milk by-product are replaced by alkali ions. The present method has to fulfill beside an elimination of Ca and Mg ions to an extremely low level from the milk by-product, a reduction of effluent to an extremely low level by separating and recycling of minerals exploding the whole potential of downstream processing, and also an important improvement of downstream processing and final products regarding to yield and quality.

According to a preferred embodiment the weak cationic resin (WAC) is charged with Na⁺ ions or K⁺ ions, or any combination thereof, wherein after passing said milk by-products through said weak cationic resin, the weak cationic resin is regenerated in its alkali form.

R═Ca+2HCl->R—(H)2+CaCl2 (2)

R—(H)+NaOH->R—Na+H2O (3)

WAC resins retain preferable divalent alkali-earth cations like Mg++ and Ca++, binding affinity is following the sequence Na<K<<Mg, Ca<H. Due to this ranging of affinity WAC resins can be transferred with only a small excess of diluted acid (2) completely into the H-form. Further on a small excess of sodium or potassium hydroxide with high pH-value will transfer the resin completely into the alkali-form (3). The alkali earth ions which are fixed completely in step (4) on the resin, are eluted in a second step with any acid, like lactic acid, phosphoric acid or citric acid, or by any acidic beverage or milk drink to be transferred to a final product in powder or liquid form.

Already at slightly acidic pH-value WAC resins will partly turn into the H-form, which is the most stable form under acidic conditions. The binding of cations will stay incomplete as being shown already above in (1). Only when whey or other milk by-products are percolated over a WAC resin in its alkali-form, as described in the present invention, Na and/or K ions exchanged against Mg and Ca ions (4).

2R—Na+Ca++=R2=Ca+2Na+(pH-value unchanged) (4)

This reaction will run quantitatively without any major change of the pH-value. The big capacity of the WAC resin will be fully applied to take out alkali-earth ions completely of a volume of whey, which is several times bigger than during the standard demineralisation using the ion exchange resin in the H-form.

It is preferred that the regeneration comprises two steps, wherein in a first step the cations on the weak cationic resin are eluated by means of contacting said weak cationic resin with an aqueous acid solution, and in the second step the weak cationic resin thus treated is transferred in its alkali form by means of contacting said weak cationic resin with an aqueous basic solution.

The alkali earth ions which are fixed completely in a first step on the resin, are eluted in a second step with any acid, like lactic acid, phosphoric acid or citric acid, or by any acidic beverage or milk drink to be transferred to a final product in powder or liquid form. Further on was found, that all milk by-products, which are transferred by this process completely into the alkali form, show an improved performance during all kinds of follow up processes like crystallisation of lactose and all kinds of membrane processes (ultrafiltration, nanofiltration, electrodialysis etc) in regard to product yield, quality aspects and fouling of the equipment and specially membranes. Applying the invented process on whey demineralisation, consumption of process chemicals and amount of effluent is reduced essentially and recycling of all whey minerals becomes feasible.

Further on was found, that all milk by-products, which are transferred by this process completely into the alkali form, show an improved performance during follow up processes like crystallization of lactose and all kinds of membrane processes (ultrafiltration, nanofiltration, electrodialysis etc) in regard to product yield, quality aspects and fouling of the equipment and specially membranes. Applying the present process on whey demineralisation, consumption of process chemicals and amount of effluent is reduced essentially and recycling of all whey minerals becomes feasible.

Permeates, both from milk microfiltration and also the permeates from ultrafiltration of whey are characterized by similar high mineral contents as found in cheese whey. For the treatment of whey and related liquid by-products all kinds of different separation steps are put together in systems, which are created to achieve product targets in a most efficient way.

One often applied system starts off with an ultrafiltration step to collect whey proteins in the retentate, while the permeate is concentrated by nanofiltration and evaporation to gain finally lactose by crystallization. Microfiltration of skimmed milk is another way to produce a permeate which is very similar to whey and which forms after nanofiltration, ultrafiltration or chromatographically absorption base for whey protein isolates.

The present invention relates to a process for treating by-products of milk to produce alkali earth metal based formulations. The process allows to isolate and to recover completely all Calcium and Magnesium from milk by-products by means of binding all Calcium and Magnesium on a weak acidic cation exchange resin with carboxylic functional groups in its alkali form and subsequently eluting Calcium and Magnesium with any chosen acidic liquid. The eluate will then be worked up to any wanted liquid or powder final formulation.

The present invention relates to a milk by-product obtainable according to the process as mentioned above, wherein the concentration of magnesium and/or calcium from the milk by-product thus treated is reduced to a concentration less then 1% by weight, compared to the initial concentration of the untreated milk by-product.

By-products of milk like whey from cheese or casein production but also permeates from ultrafiltration of whey from whey protein isolation or permeates from microfiltration of skimmed milk are used, beside in animal feed mixes, as base for isolation of a big range of products taking advantage of the high value of whey proteins and lactose.

For example one preferred starting material available in large quantities is sweet whey, emanating as by-product in cheese making, of which the approximate composition by weight is as follows.

| | % |
|---|---|
| Lactose | 4.0 to 5.0 |
| Proteins | 0.6 to 0.8 |
| Minerals | 0.4 to 0.6 |
| Dry matter | 5.3 to 6.6 |

It can be noted, that besides being a highly diluted liquid, whey composition is ruled by similar amounts of protein with high value on one hand and of minerals on the other hand, which have to be taken out for most applications. Permeates, both from milk microfiltration and also the permeates from ultrafiltration of whey are characterised by similar high mineral contents as found in cheese whey.

For the treatment of whey and related liquid by-products all kinds of different separation steps are put together in systems, which are created to achieve product targets in a most efficient way.

One often applied system starts off with an ultrafiltration step to collect whey proteins in the retentate, while the permeate is concentrated by nanofiltration and evaporation to gain finally lactose by crystallisation.

Microfiltration of skimmed milk is another way to produce a permeate which is very similar to whey and which forms after nanofiltration, ultrafiltration or chromatographically absorption base for whey protein isolates.

The weak acidic cation (WAC) resin used may be, for example, an AMBERLITE IRA-84, a product of Rohm and Haas Company, consisting of beads of cross-linked acrylic acid polymer containing carboxylic functional groups.

Capacity of WAC resins is at 4 eq./lt and so much bigger, when compared to a strong acidic cationic (SAC) resins with a nominal capacity of about 1.7 eq./lt.

While SAC resins have to be regenerated into its H-form with a excess of a strong acid like for example hydrochloric acid at concentration of >4%, WAC resins can be transferred with only a small excess of diluted acid completely into the H-form and further on with a small excess of sodium or potassium hydroxide also completely into the alkali-form.

WAC resins retain preferable divalent alkali-earth cations like Mg⁺⁺ and Ca⁺⁺, binding affinity is following the sequence Na<K<<Mg, Ca.

Already at slightly acidic pH-value WAC resins will partly turn into the H-form, which is the most stable form under acidic conditions.

When whey or other milk by-products are percolated over a WAC resin in its alkali-form, as described in the present invention, Na and/or K ions are exchanged against Mg and Ca ions (1*).

2R—Na+Ca⁺⁺═R2=Ca+2Na+(pH-value unchanged) (1*)

This reaction will run nearly quantitatively without any major change of the pH-value. The big capacity of the WAC resin will be fully applied to take out alkali-earth ions completely of a volume of whey, which is several times bigger than during the standard demineralisation using SAC ion exchange resin in the H-form.

In U.S. Pat. No. 4,803,089 WAC resin was applied the first time in the demineralisation process of whey, but the WAC resin was applied in the H-form, which will result in a reduced capacity of the resin and an incomplete reduction of Mg and Ca ions, because of the rapid drop of the pH-value during percolation (2*).

2R—H+Ca⁺⁺═R═Ca+2H+(shift to acidic pH-value) (2*)

As mentioned in U.S. Pat. No. 4,803,089 approximately 50% of Ca⁺⁺ and Mg⁺⁺ ions are fixed on the WAC resin in the acidic H-form.

It was found out, that in order to elute a high quality calcium/magnesium solution and to facilitate real breakthrough improvement of all follow up membrane process steps on the resulting milk by-product, complete reduction and separation of all alkali earth ions of the milk by-product is the key element.

Treatment of the milk by-product on WAC resin can be carried out by percolation of the liquid product downwards over the resin in a column or in a mixing reactor at a temperature range from 4° C. to 40° C., and preferable at a temperature in the range of 4° C. to 15° C.

Beside creating product formulations with an extra portion of milk Calcium and milk Magnesium the present invention will result for the first time in milk by-products, which are completely free of any Calcium and Magnesium.

Benefits of this achievement can be demonstrated on the example of whey demineralisation.

Sweet whey is a preferred starting material available in large quantities. It is emanating as by-product in cheese making and its approximate composition by weight can be summarised as follows.

Benefits of the present invention are identified under three different aspects, which are valid for most of the operations applied to work up milk by-products:

1. Improve performance of membrane processes and of crystallisation yield

2. Reduce consumption of chemicals for regeneration and reduce amount of effluent from the plant

3. Splitting up effluents for further uses and recycling of milk minerals Complete replacement of alkali earth ions by alkali ion as proposed from the whey product has a positive influence on the performance and the running time of operation like electrodialysis, nanofiltration and ultrafiltration.

During electrodialysis efficiency of demineralisation is ruled by the conductivity of the whey; it was found, that when calcium and magnesium are replaced, conductivity of the whey is increased by 24%. With this increased conductivity a demineralisation degree below 90% is feasible at unchanged running conditions compared to a demineralisation degree of 70%.

Further on a very important increase of the life span of electrodialysis membranes can be expected, since most of membrane fouling conducted without pre-treatment is caused by deposits, which contain calcium and magnesium.

Similar conditions can be expected, when a standard electrodialysis is replaced by an electrodialysis with bipolar membranes. The present invention offers the opportunity to apply electrodialysis with bipolar membranes for demineralisation of whey, since in order to avoid membrane blockage, the whey must be strictly free of any calcium ions. On the other hand acids and lye's produced from the minerals of the whey by the bipolar membranes system have the right concentration to regenerate the weak cation resin used regarding to the present invention for the pre-treatment of the whey.

Both ultrafiltration and nanofiltration of milk by-products are membrane processes and their performance is highly impaired by fouling by calcium and magnesium containing deposits. With a pre-treatment of the milk by-product as described in the present invention, performance and run time of such operations are improved essentially.

Yields of crystallisation of lactose from milk by-products like for example permeates from the ultrafiltration of whey are limited deposits of calcium phosphates, which will block the plant and start to precipitate at concentrations of the permeates above 60% of total solids.

After re-movement of all calcium and magnesium from the permeate, as described in the present invention, all remaining salts are extremely soluble and concentration of the permeate can be pushed up, which will increase the yield of lactose significantly, i.e. >80%.

If whey concentrates are treated as described in the present invention with a weak cation resin in its alkali form and are successively demineralised by electrodialysis, a demineralisation degree below 90% will be achieved without any further ion exchange resins used to finish up demineralisation and to create extra amounts of minerals in the effluent.

To apply the procedure as described in the patent to milk by-products offers a first possibility to separate different species of minerals from other, which will open up further opportunities to split up and to recycle other milk minerals.

TABLE
Benefits of the present invention on demineralisation
process of whey in comparison to the actual situation

| | |
|---|---|
| Increased conductivity = | Demineralisation degree of >90% by |
| | electrodialysis only |
| No final ion exchange needed = | No effluent from regeneration of resins |
| Less membrane fouling = | Increase of life span of membranes |
| Separate earth alkali minerals = | Turn effluent into added value product |
| Option to use bipolar | Option to recycle whey minerals |
| membranes = | |

### EXAMPLE 1

Pre-treatment of sweet whey concentrate 60 l of whey (14.98 kg of whey dry matter) from cheese production at 22.9% TS is successively passed at 13° C. through a column charged with 1.5 l (resin measured as apparent volume of the H-form) of weak cationic resin (WAC) in its Na-form. The flow was constantly fixed at 8.6 lt per hour (5.7 bed volumes/h).

Whey was pushed out and the batch of the first 28 BV of treated whey concentrate was demineralised without any problem by electrodialysis to a degree of 94%.

Regeneration of the weak cationic resin for the treatment of next batch of whey concentrate is described in

Table 1 below shows the concentration, the pH and the quantities of principle cations in the starting whey and in the accumulated batches at the exit of the column as monitored during the whole run.

TABLE 1

| mg/100 gTS | % TS | pH | Na | K | Mg | Ca |
|---|---|---|---|---|---|---|
| Start | 22.9 | 6.3 | 743 | 2749 | 123 | 507 |
| 4 BV | 23.2 | 7.2 | 3026 | 66 | 0 | 4 |
| 8 BV | 23.5 | 6.9 | 2888 | 174 | 0 | 4 |
| 12 BV | 23.6 | 7.1 | 2571 | 758 | 0 | 4 |
| 16 BV | 23.6 | 6.8 | 2278 | 1058 | 0 | 4 |
| 20 BV | 23.7 | 6.8 | 2047 | 1458 | 0 | 4 |
| 24 BV | 23.6 | 6.6 | 1868 | 1716 | 1 | 5 |
| 28 BV | 23.6 | 6.5 | 1727 | 1891 | 5 | 9 |
| 32 BV | 23.6 | 6.5 | 1607 | 1999 | 12 | 21 |
| 36 BV | 23.6 | 6.4 | 1507 | 2070 | 21 | 37 |
| 40 BV | 23.6 | 6.4 | 1456 | 2187 | 27 | 49 |

Table 2 below shows the mass balance of the cations in grams, after treatment of 28 bed volumes of whey concentrate on the column Mg is reduced to 2.6% and Ca is reduced to 1.2% of the initial values.

TABLE 2

| in gram | Na | K | Mg | Ca |
|---|---|---|---|---|
| Theor. Resin + Whey | 245.9 | | | |
| in Whey Batch | 111.3 | 411.8 | 19.5 | 76.0 |
| after 28 BV | 181.1 | 198.3 | 0.5 | 0.9 |
| after 32 BV | 192.6 | 239.7 | 1.4 | 2.5 |
| after 40 BV | 218.1 | 327.0 | 4.0 | 7.3 |
| In Eluate after Regeneration | 22.2 | 78.2 | 18.9 | 74.9 |

### EXAMPLE 2

Regeneration of the Weak Acidic Cation Exchange Resin

After whey concentrate from EXAMPLE 1 has been pushed out, the weak acidic cation resin was regenerated in two steps.

In the first step, experience has shown, HCl has to be used in a quantity only 10% higher than the adsorption capacity, i.e., 6.4 eq. HCl on 1.5 l of resin with an adsorption capacity of 3.9 eq./l of the weak acidic cation resin. 3.35 l of 7% hydrochloric acid solution was percolated at speed of 3 l per hour through the resin and subsequently rinsed with 9 l of water.

In the second step, experience has shown, alkali hydroxide (Na or/and K) has to be used in a quantity 10% higher than the adsorption capacity, i.e., 6.4 eq. alkali hydroxide/on 1.5 l of resin with an adsorption capacity of 3.9 eq./l of the weak acidic cation resin.

6.44 l of 4% sodium hydroxide solution was percolated at speed of 3 l per hour through the resin and subsequently rinsed with 9 l of water.

The resin was ready for the following batch of whey.

### EXAMPLE 3

Pre-treatment of permeate concentrate from ultrafiltration of whey 60 l of permeate (15.18 kg of dry matter) from ultrafiltration of cheese whey at 22.9% TS is successively passed at 14° C. through a column charged with 1.5 l (resin measured as apparent volume of the H-form) of weak cationic resin (WAC) in its Na-form. The flow was constantly fixed at 7.8 lt per hour (5.2 bed volumes/h).

Finally the permeate was pushed out and out of the batch up to 32 BV of treated permeate lactose was crystallised at a yield >90%.

Regeneration of the weak cationic resin for the treatment of next batch of whey concentrate is described in EXAMPLE 2.

Table 3 below shows the concentration, the pH and the quantities of principle cations in the starting whey and in the accumulated batches at the exit of the column as monitored during the whole run.

TABLE 3

| mg/100 gTS | % TS | pH | Na | K | Mg | Ca |
|---|---|---|---|---|---|---|
| Start | 23.2 | 6.3 | 803 | 2790 | 121 | 656 |
| 4 BV | 23.2 | 7.2 | 3026 | 96 | 0 | 4 |
| 8 BV | 23.4 | 6.9 | 2888 | 251 | 0 | 3 |
| 12 BV | 23.6 | 7.0 | 2571 | 730 | 0 | 3 |
| 16 BV | 23.5 | 6.8 | 2278 | 1088 | 0 | 4 |
| 20 BV | 23.5 | 6.9 | 2047 | 1459 | 0 | 5 |
| 24 BV | 23.6 | 6.6 | 1868 | 1833 | 1 | 5 |
| 28 BV | 23.7 | 6.5 | 1727 | 1869 | 1 | 10 |
| 32 BV | 23.7 | 6.5 | 1607 | 2056 | 7 | 11 |
| 36 BV | 23.6 | 6.5 | 1507 | 2122 | 11 | 30 |
| 40 BV | 23.6 | 6.5 | 1422 | 2140 | 27 | 48 |

### EXAMPLE 4

Pre-Treatment of Fresh Whey (5.6% of Total Solids)

62.3 l of whey (3.5 kg of dry matter) from production of cheese at 5.6% TS is successively passed at 13° C. through a column charged with 0.5 l (resin measured as apparent volume of the H-form) of weak cationic resin (WAC) in a mixed Na/K-form. The flow was constantly fixed at 3.6 lt per hour (7.2 bed volumes/h).

The whey was pushed out and the whole batch of earth alkali free whey was concentrated by nanofiltration to 25% of TS and a demineralisation degree >60%

Regeneration of the weak cationic resin for the treatment of next batch of whey concentrate is described in EXAMPLE 2.

Table 4 below shows the concentration, the pH and the quantities of principle cations in the starting whey and in the accumulated batches at the exit of the column as monitored during the whole run.

TABLE 4

| mg/100 gTS | Na | K | Mg | Ca |
|---|---|---|---|---|
| Start | 784 | 2655 | 120 | 642 |
| Treated Batch | 1191 | 3570 | 1 | 2 |

According to the present invention, examples of “by-products of milk” are:

whey emanating from the conversion of milk into cheese, casein or casein derivatives by coagulation with rennet (sweet) or by the acid method (acidic);

the permeate emanating from the microfiltration of skimmed milk;

solutions emanating from the deproteinisation of whey, for example, ultrafiltration permeate;

all afore-mentioned products in reconstituted or concentrated to a dry matter content from 5 to 25% of total solid.

1. A process for removing divalent cations from milk by-products comprising passing the milk by-products through a weak cationic resin, wherein the weak cationic resin is in the alkali form.

2. The process according to claim 1, wherein the weak cationic resin is charged with Na⁺ ions, K⁺ ions or any combination thereof.

3. The process according to claim 1, wherein after passing the milk by-products through the weak cationic resin, the weak cationic resin is regenerated in its alkali form.

4. The process according to claim 3, wherein the regeneration comprises two steps, wherein in a first step the cations on the weak cationic resin are eluated by means of contacting the weak cationic resin with an aqueous acid solution, and in a second step the threated weak cationic resin is transferred in its alkali form by means of contacting the weak cationic resin with an aqueous basic solution.

5. The process according to claim 1, wherein the process further comprises passing the weak cationic resin processed milk by-products through an electrodialysis.

6. The process according to claim 5, wherein the electrodialysis comprises electrodialysis with bipolar membranes.

7. The process according to claim 1, wherein the process further comprises a step of collecting lactose from the weak cationic resin processed milk by-products.

8. The process according to claim 7, wherein the step of collecting lactose comprises crystallization.

9. The process according to claim 1, wherein the milk by-products are selected from the group consisting of cheese whey, casein whey, permeate from microfiltration of skimmed milk, and permeate from ultrafiltration of whey, or any combination thereof.

10. The process according to claim 1, wherein the milk by-products have a dry matter content of from 17% to 26% by weight, on basis of the total weight of the milk by-product.

11. A milk by-product obtainable according to the process of claim 1, wherein the concentration of magnesium ions in the milk by-product thus treated is reduced to less than 1% by weight, compared to the initial concentration of the untreated milk by-product.

12. A milk by-product obtainable according to the process of claim 1, wherein the concentration of calcium ions in the milk by-product thus treated is reduced to less than 1% by weight, compared to the initial concentration of the untreated milk by-product.
